(19) United States
(12) Patent Application Publication
(10) Pub. No.: US 2026/0105110 A1
(43) Pub. Date: Apr. 16, 2026

(54) SYSTEM AND METHOD FOR TOPIC-BASED CONTENT ORGANIZATION, DATA TAGGING, AND PERSONALIZED FEED GENERATION

(71) Applicant: Aaron Spence, King of Prussia, PA (US)

(72) Inventor: Aaron Spence, King of Prussia, PA (US)

(21) Appl. No.: 19/347,415

(22) Filed: Oct. 1, 2025

Related U.S. Application Data
(60) Provisional application No. 63/706,658, filed on Oct. 12, 2024.

(51) Int. Cl. G06F 16/9536; G06F 16/951

(52) U.S. Cl. CPC G06F 16/9536; G06F 16/951

(57) ABSTRACT

Embodiments include a computer-implemented data tagging and filtering system for social media platforms enables users to organize and filter content by personalized interests. Embodiments include a topic-creation module for defining posting topics, a topic-following module for subscribing to topics, and a data tagging subsystem with a tagging interface, metadata generator, storage module, and indexing engine. Posts and comments are assigned metadata fields including topic identifiers, timestamps, user identifiers, and content-type indicators, and stored in a searchable database. An Artificial Intelligence assistant processes user posts, profile information, activity, and metadata to rank posts, suggest topics, and organize topics into sub-topics. A topic-subscription engine records selected topics from multiple publisher accounts, and a feed composer generates consolidated feeds containing only content tagged with selected topics. The presentation graphical user interface displays feeds to client devices, supporting real-time updates, topic merging, credential attachment, and advanced filtering for enhanced content relevance.

### CROSS REFERENCE TO RELATED APPLICATIONS

This application claims the priority benefit of U.S. Provisional Patent Application Ser. No. 63/706,658 filed on Oct. 12, 2024 and titled “Topical based social media platform app,” which is hereby incorporated by reference in its entirety including all references cited therein.

### FIELD OF THE TECHNOLOGY

The present disclosure pertains to computer-implemented social media systems, and more specifically to data tagging, topic-based content organization, and personalized feed generation using artificial intelligence.

### BACKGROUND

The approaches described in this section could be pursued, but are not necessarily approaches that have previously been conceived or pursued. Therefore, unless otherwise indicated, it should not be assumed that any of the approaches described in this section qualify as prior art merely by virtue of their inclusion in this section.

The present disclosure relates generally to computer-implemented social media platforms and content delivery networks. More particularly, the field encompasses systems and methods for organizing user-generated content by topic, tagging that content with metadata, and generating personalized feeds through artificial intelligence techniques. Such systems may be deployed on distributed computing environments, including cloud-based architectures and mobile client devices, and may involve graphical user interfaces, network protocols, and storage subsystems. The present context also addresses the need for efficient metadata management, dynamic content retrieval, and user-centric feed composition to support modern communication and knowledge-sharing paradigms.

Social media has transitioned from early campus-oriented networks into vast platforms where users interact through posts, comments, multimedia, and other shared content. In this environment, subscribers often have diverse and evolving interests spanning multiple domains, such as sports, entertainment, professional topics, and personal hobbies. Conventional approaches strive to present relevant content by grouping posts by user accounts or simple heuristics, but they often fail to capture the nuanced topics that drive individual engagement. There exists a demand for systems that enable posting users to categorize content under thematic headings and for subscribing users to receive notifications or feeds tied specifically to those themes. By focusing on interest-based categorization rather than account-level following, such platforms aim to reduce information overload and improve the relevance and timeliness of delivered content.

Existing social media systems predominantly center on following individual profiles or channels, resulting in content streams that aggregate all activity of selected accounts without regard to thematic relevance. This model can inundate users with off-topic updates, leading to disengagement and missed opportunities to connect with strictly relevant material. Moreover, rigid account-based feeds may obscure emerging trends within broader interest areas and limit the discoverability of novel content that lies outside a user's explicit subscriptions. While some platforms incorporate basic filters or keyword searches, these mechanisms are often manual and lack the intelligence needed to seamlessly surface the most pertinent posts across a diverse network of contributors.

From a data analysis and advertising perspective, the lack of granular topic-level organization poses significant challenges. Advertisers and analytics services are hindered by the inability to extract precise metadata that aligns with specific subject matter, which reduces the effectiveness of targeted campaigns and predictive insights. Similarly, content creators and community managers encounter difficulty in managing and promoting topic-centric discussions when metadata tagging and dynamic feed composition are limited. The absence of automated, AI-driven subtopic extraction and customizable feed generation exacerbates these shortcomings, highlighting the need for a more elegant solution to tag, filter, and rank content by thematic relevance while preserving scalability and ease of integration into existing network architectures.

### SUMMARY OF EXEMPLARY EMBODIMENTS

In some aspects, the techniques described herein relate to a data tagging and filtering system for sharing content that enables a user to filter the content based on personalized interests of the user, the data tagging and filtering system including: a topic-creation module configured to allow a posting user to define posting topics and publish the content under the posting topics; a topic-following module configured to allow a subscribing user to define subscribing topics and receive the content under the subscribing topics; a data tagging and filtering subsystem enabling matching of the posting topics and the subscribing topics, the data tagging and filtering subsystem including: a tagging interface configured to receive, one or more topic selections from the posting user for each post or comment from the posting user; a metadata generator configured to automatically assign to each post or comment from the posting user a set of metadata fields including a topic-specific identifier, a content-type indicator, a timestamp, a user identifier, and a post identifier; a storage module configured to store the post or comment from the posting user with the set of metadata fields associated with the post or comment in a searchable database; an indexing engine that creates and maintains an index mapping topic identifiers to post identifiers for efficient retrieval during searching of the searchable database, the topic identifiers including the topic-specific identifier and the content-type indicator; and a retrieval module that, responsive to a feed request from a feed composer, matches the topic identifiers in the set of metadata fields to the subscribing topics selected by the subscribing user and returns only posts or comments with matching topic identifiers enabling matching of the posting topics and the subscribing topics; an Artificial Intelligence (AI) assistant to assist in filtering the posting topics into posting sub-topics by taking input data including: the set of metadata fields for each post or comment, user profile information, and user activity including subscriptions and interactions with other posts; and generating an output including ranked posts in a data stream and suggested posts from accounts or topics, the data stream including a news feed; a topic-subscription engine that records, for each subscribing user, individual topics selected from a plurality of publisher accounts, the plurality of publisher accounts including the posting user; a feed composer operative to produce, for each subscribing user, a consolidated feed including curated content tagged with individually selected topics regardless of posting user; and a presentation graphical user interface configured to display the consolidated feed to a client device of the subscribing user, the consolidated feed including the curated content.

In some aspects, the techniques described herein relate to a system, wherein the topic-creation module further enables the posting user to designate a visibility setting for each posting topic, the visibility setting being selectable between a public mode and a private mode.

In some aspects, the techniques described herein relate to a system, further including a post elevation module configured to receive an elevation command from a moderator user, evaluate a metric including at least one of a number of likes and a rate of interactions, and set a visibility flag in the set of metadata fields when the metric satisfies a threshold.

In some aspects, the techniques described herein relate to a system, wherein the AI assistant employs a machine-learning model that clusters the posting topics and automatically generates recommended sub-topic identifiers exposed to the subscribing user via a graphical subscription interface.

In some aspects, the techniques described herein relate to a system, wherein the topic-following module is further configured to allow the subscribing user to organize subscribing topics into custom-named feeds.

In some aspects, the techniques described herein relate to a system, wherein the data tagging and filtering subsystem further includes a comment tagging interface configured to allow users to tag comments with one or more topic identifiers.

In some aspects, the techniques described herein relate to a system, wherein the storage module is further configured to store posts and comments in association with a hierarchical topic structure including parent topics and sub-topics.

In some aspects, the techniques described herein relate to a system, wherein the retrieval module is further configured to filter posts and comments based on a filter selection by the subscribing user, the filter selection including at least one of: only owner posts, all user comments, only comments elevated by the owner, and posts liked by the subscriber above a threshold.

In some aspects, the techniques described herein relate to a system, wherein the presentation graphical user interface is further configured to display, for each post in the consolidated feed, a link to an original post under a topic page from which the post originated.

In some aspects, the techniques described herein relate to a system, wherein the topic-subscription engine is further configured to allow a subscribing user to subscribe to multiple topics from multiple publisher accounts and aggregate posts from all selected topics into a single feed.

In some aspects, the techniques described herein relate to a system, wherein the AI assistant is further configured to suggest new topics or sub-topics to the posting user based on analysis of user activity and trending content.

In some aspects, the techniques described herein relate to a system, wherein the feed composer is further operative to update the consolidated feed in real-time responsive to new posts, comments, or topic changes.

In some aspects, the techniques described herein relate to a system, wherein the presentation graphical user interface is further configured to allow the subscribing user to block or delete comments from their feed.

In some aspects, the techniques described herein relate to a system, wherein the topic-creation module is further configured to allow the posting user to merge topics with topics created by other users.

In some aspects, the techniques described herein relate to a system, wherein the data tagging and filtering subsystem is further configured to allow the posting user to attach credentials to posts under selected topics.

In some aspects, the techniques described herein relate to a system, wherein the AI assistant is further configured to rank posts in the consolidated feed based on relevance to profile attributes of the subscribing user and activity history of the subscribing user.

In some aspects, the techniques described herein relate to a computer-implemented method for generating machine-determined sub-topics for a parent topic in a social-media platform, the method including: aggregating, for the parent topic, content items posted under the parent topic, profile attributes of users interacting with the content items, and temporal interaction data; processing the aggregated data with a machine-learning model to cluster the aggregated data into a plurality of sub-topic clusters, the processing the aggregated data with the machine-learning model including generating an embedding for each content item using a neural network language model and applying a clustering algorithm to the embeddings, the generating the embedding for each content item using the neural network language model including tokenizing of each content item generating tokens, converting the tokens into vector representations, and processing the vector representations through one or more layers of the neural network to produce a fixed-length embedding vector; assigning, by the platform, a system-generated sub-topic identifier to each sub-topic cluster; updating a stored topic hierarchy such that the sub-topic identifiers are children of the parent topic; and exposing the sub-topic identifiers as selectable subscription options in a graphical user interface.

In some aspects, the techniques described herein relate to a method, wherein the clustering algorithm applied to the embeddings is selected from the group consisting of k-means clustering, hierarchical clustering, and density-based spatial clustering.

In some aspects, the techniques described herein relate to a method, further including updating a recommendation engine to utilize the sub-topic identifiers when calculating likelihood scores for recommending topics to users not yet subscribed to the parent topic.

In some aspects, the techniques described herein relate to a method, further including updating a recommendation engine to utilize the sub-topic identifiers when calculating likelihood scores for recommending topics to users not yet subscribed to the parent topic.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

FIG. 1 illustrates an environment within which systems and methods for data tagging and filtering for topic-based content organization, and personalized feed generation, according to embodiments of the present technology.

FIG. 2 shows a high-level block diagram of an exemplary system for data tagging and filtering for topic-based content organization, and personalized feed generation, according to embodiments of the present technology.

FIG. 3 shows another a high-level block diagram of an exemplary system for data tagging and filtering for topic-based content organization, and personalized feed generation, according to embodiments of the present technology.

FIG. 4 illustrates an exemplary graphical user interface (GUI) showing a topic for the consolidated content data feed, according to embodiments of the present technology.

FIG. 5 illustrates an exemplary graphical user interface (GUI) showing a my topics page of a subscribing user, according to embodiments of the present technology.

FIG. 6 illustrates an exemplary graphical user interface (GUI) showing a knowledge post by a posting user, according to embodiments of the present technology.

FIG. 7 illustrates an exemplary graphical user interface (GUI) showing a post request by a subscribing user to a posting user, according to embodiments of the present technology.

FIG. 8 illustrates an exemplary graphical user interface (GUI) showing a followed topics page by a subscribing user, according to embodiments of the present technology.

FIG. 9 illustrates an exemplary graphical user interface (GUI) showing a subscriptions page by a subscribing user including topics of interest to the subscribing user, according to embodiments of the present technology.

FIG. 10 illustrates an exemplary graphical user interface (GUI) showing a saved subscriptions page by a subscribing user including saved topics of interest to the subscribing user, according to embodiments of the present technology.

FIG. 11 illustrates an exemplary graphical user interface (GUI) showing an inside subscriptions page by a subscribing user, according to embodiments of the present technology.

FIG. 12 illustrates an exemplary graphical user interface (GUI) showing trending recommendation subscriptions page to a subscribing user, according to embodiments of the present technology.

FIG. 13 illustrates an exemplary computer system that may be used to implement embodiments of the present disclosure.

### DETAILED DESCRIPTION OF EXEMPLARY EMBODIMENTS

The following detailed description provides illustrative examples of the systems and methods disclosed herein. These examples are intended to facilitate an understanding of the disclosed subject matter and are not to be construed as limiting the scope of the claims. The disclosed subject matter pertains to the field of computer-implemented social media platforms, with a particular focus on systems and methods for organizing user-generated content by topics, tagging such content with metadata, and generating personalized feeds using artificial intelligence. The disclosed technology addresses challenges in content relevance, user engagement, and metadata management within modern social media environments.

The embodiments described herein are provided as illustrations, and various modifications, substitutions, or rearrangements of components and processes may be implemented without deviating from the scope of the described subject matter. Certain widely recognized elements, protocols, and techniques frequently utilized in the field of social media systems and distributed computing environments may be omitted or described in a generalized manner for the sake of clarity and conciseness. The described subject matter is intended to include all such variations and adaptations that align with the spirit and scope of the appended claims.

Social media platforms have traditionally been designed around the concept of following individual user accounts, resulting in content streams that aggregate all activity from selected accounts. While this model allows users to stay updated on the activities of specific individuals, the approach often leads to information overload and a lack of relevance. Users are inundated with posts that may not align with their specific personalized interests, as the platforms fail to distinguish between the diverse topics a single user might post about. For example, a celebrity might share content spanning tennis, family life, business ventures, and sponsorships, yet a follower interested only in tennis is required to sift through unrelated posts. This account-focused approach limits user engagement, obscures emerging trends within broader interest areas, and reduces the discoverability of novel content outside explicit subscriptions. Furthermore, advertisers and analytics services face challenges in extracting precise metadata tied to specific topics, which complicates targeted campaigns and predictive insights.

Existing solutions, such as keyword searches or basic filters, provide limited relief but require manual intervention and lack the intelligence to dynamically surface the most relevant content. These systems fail to leverage advanced technologies, such as artificial intelligence, to organize content at a granular, topic-specific level. Additionally, rigid account-based feeds restrict the ability to create personalized content streams tailored to individual interests, further exacerbating the problem of irrelevant content delivery.

The present disclosure addresses these shortcomings by introducing a topic-based content organization and personalized feed generation system powered by artificial intelligence. Unlike conventional approaches, the described system enables users to follow specific topics rather than entire user accounts, allowing for a more focused and relevant content experience. Posting users can categorize their content under thematic headings, while subscribing users can create custom feeds based on selected topics. This eliminates the need to follow all activities of a user and instead focuses on the areas of interest most relevant to the subscriber.

The system employs a sophisticated data tagging subsystem that assigns metadata to posts and comments, including topic-specific identifiers, timestamps, and user attributes. An indexing engine maps topic identifiers to post identifiers, enabling efficient retrieval of content. Additionally, an artificial intelligence assistant leverages machine learning models to analyze user activity, profile information, and metadata, dynamically suggesting sub-topics and ranking posts for personalized feeds. The system architecture supports real-time updates, allowing consolidated feeds to reflect new posts, comments, or topic changes instantaneously. By integrating these advanced features, the described system not only enhances content relevance and user engagement but also provides advertisers and analytics services with granular, topic-specific insights for improved targeting and campaign effectiveness.

In some embodiments, the system includes a feature by which a user creates topics of interest for themselves and others to post content related to the user-created topic. The system further includes a feature by which other users (subscriber users) subscribe to the topic and receive notifications for new updates regarding the topic. In some embodiments, the subscriber can create one or more individual topic-based feeds based on those topics.

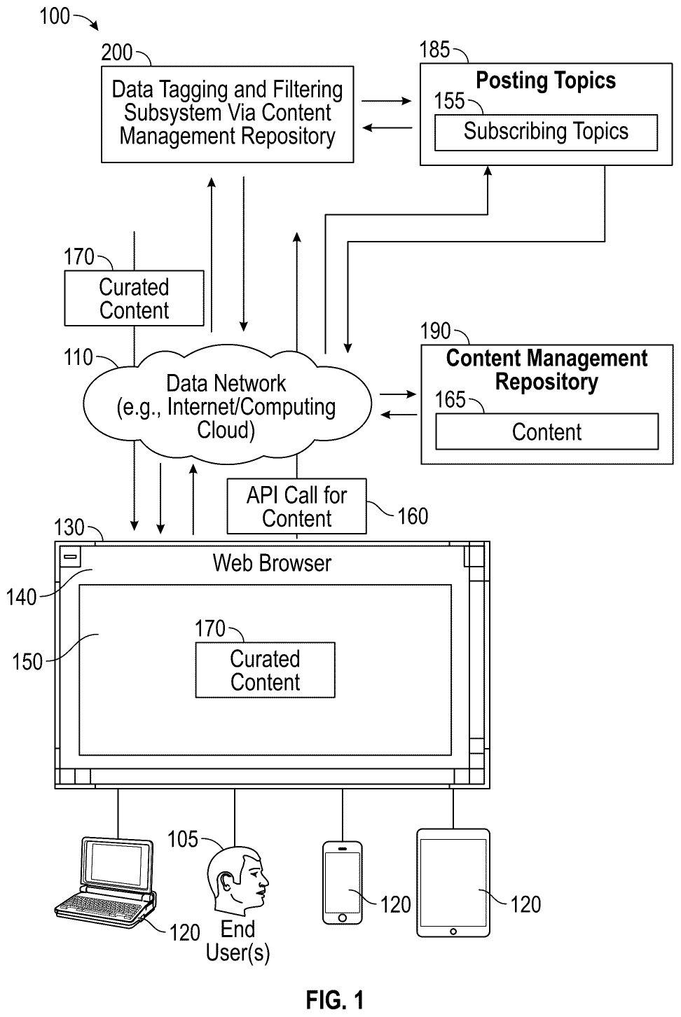

Referring now to the drawings, FIG. 1 illustrates an environment 100 within which systems and methods for data tagging and filtering for topic-based content organization, and personalized feed generation via a content management repository may be implemented. The environment 100 may include a data network 110 (e.g., an Internet or a computing cloud), end user(s) 105, client device(s) 120 associated with the end user(s) 105 (e.g., posting users and subscribing users), and a data tagging and filtering subsystem 200 (also referenced as “system 200”) via a content management repository 190. Client device(s) 120 may include a personal computer (PC), a desktop computer, a laptop, a smartphone, a tablet, or so forth.

The client device 120 may have a presentation graphical user interface (GUI) shown as a user interface 130 associated with the system 200. Furthermore, a web browser 140 may be running on the client device 120 and displayed using the presentation graphical user interface 130. The web browser 140 may communicate with the system 200 via the data network 110.

The data network 110 may include the Internet or any other network capable of communicating data between devices. Suitable networks may include or interface with any one or more of, for instance, a local intranet, a corporate data network, a data center network, a home data network, a Personal Area Network, a Local Area Network (LAN), a Wide Area Network (WAN), a Metropolitan Area Network, a virtual private network, a storage area network, a frame relay connection, an Advanced Intelligent Network connection, a synchronous optical network connection, a digital T1, T3, E1 or E3 line, Digital Data Service connection, Digital Subscriber Line connection, an Ethernet connection, an Integrated Services Digital Network line, a dial-up port such as a V.90, V.34 or V.34bis analog modem connection, a cable modem, an Asynchronous Transfer Mode connection, or a Fiber Distributed Data Interface or Copper Distributed Data Interface connection. Furthermore, communications may also include links to any of a variety of wireless networks, including Wireless Application Protocol, General Packet Radio Service, Global System for Mobile Communication, Code Division Multiple Access or Time Division Multiple Access, cellular phone networks, Global Positioning System, cellular digital packet data, Research in Motion, Limited duplex paging network, Bluetooth radio, or an IEEE 802.11-based radio frequency network. The data network can further include or interface with any one or more of a Recommended Standard 232 (RS-232) serial connection, an IEEE-1394 (FireWire) connection, a Fiber Channel connection, an IrDA (infrared) port, a Small Computer Systems Interface connection, a Universal Serial Bus (USB) connection or other wired or wireless, digital or analog interface or connection, mesh or Digi® networking.

The system 200 can receive subscribing topics 155 for content 165 stored in the content management repository 190 and inject the subscribing topics 155 into posting topics 185. The system 200 may intercept an API call 160 for content 165 from the end user(s) 105. Upon intercepting the API call 160, the system 200 may dynamically filter the content 165 based on the subscribing topics 155.

The web browser 140 can establish a communication channel with the system 200 and generate and render virtual screens based on data received from the system 200. Specifically, the web browser 140 can render the curated content 170 via the presentation graphical user interface 130 to display the curated content 170 to the end user(s) 105 (e.g., subscribing user) on a screen 150 of the client device 120.

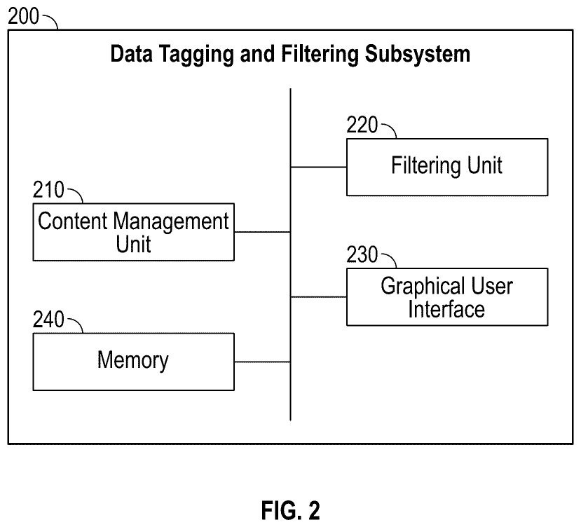

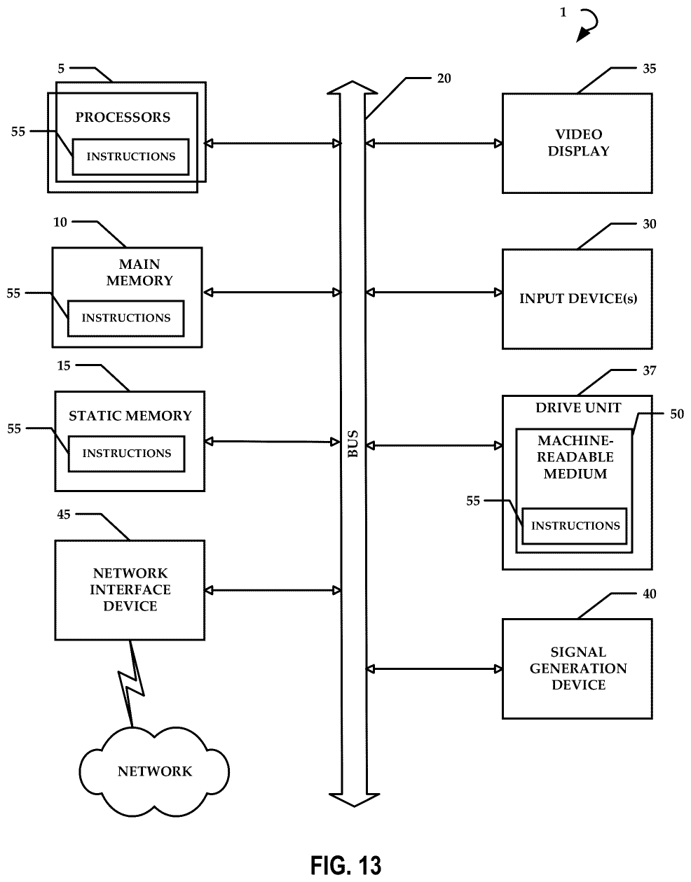

FIG. 2 is a block diagram illustrating the data tagging and filtering subsystem 200 for sharing content via a content management repository 190, according to exemplary embodiments of the present technology. The system 200 may include a content management unit 210, a filtering unit 220, a presentation GUI 230, and a memory 240. In an example embodiment, the operations performed by each of the content management unit 210, the filtering unit 220, and the presentation GUI 230 may be performed by a processor. The memory 240 may store instructions executable by the processor. Example processors are shown in FIG. 13 as one or more processors. The operations performed by each of the content management unit 210, the filtering unit 220, and the presentation GUI 230 of the system 200 are described in detail below.

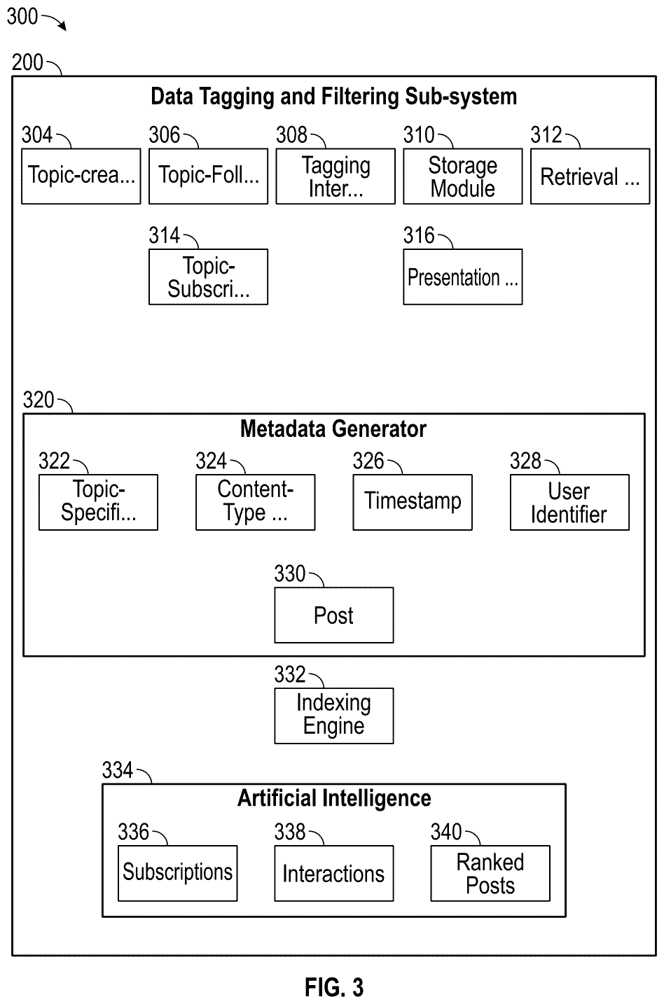

FIG. 3 is a block diagram 300 that describes the data tagging and filtering system 200, according to some embodiments of the present technology. In some embodiments, the data tagging and filtering subsystem 200 may include a topic-creation module 304 configured to allow a posting user to define posting topics and publish the content under the posting topics, a topic-following module 306 configured to allow a subscribing user to define subscribing topics and receive the content under the subscribing topics. The data tagging and filtering subsystem 200 enables matching of the posting topics and the subscribing topics and may include a metadata generator 320 configured to automatically assign to each post or comment from the posting user a set of metadata fields, a storage module 310 configured to store the post 330 or comment from the posting user with the set of metadata fields associated with the post 330 or comment in a searchable database, an indexing engine 332 that creates and maintains an index mapping topic identifiers to post identifiers for efficient retrieval during searching of the searchable database, an Artificial Intelligence 334 (AI) assistant to assist in filtering the posting topics into posting sub-topics by taking input data, and a presentation graphical user interface 316 configured to display the consolidated feed to a client device of the subscribing user.

In some embodiments, the data tagging and filtering system 200 may also include a tagging interface 308 configured to receive, one or more topic selections from the posting user for each post or comment from the posting user. The data tagging and filtering system 200 may also include a retrieval module 312 that, responsive to a feed request from a feed composer, matches the topic identifiers in the set of metadata fields to the subscribing topics selected by the subscribing user and returns only posts or comments with matching topic identifiers enabling matching of the posting topics and the subscribing topics. The data tagging and filtering system 200 may also include a topic-subscription engine 314 that records, for each subscribing user, individual topics selected from a plurality of publisher accounts. The data tagging and filtering system 200 may also include a feed composer operative to produce, for each subscribing user, a consolidated feed.

In some embodiments, the metadata generator 320 may include a topic-specific identifier 322, a content-type indicator 324, a timestamp 326, a user identifier 328, and a post 330 identifier. The Artificial Intelligence (AI) 334 may include subscriptions 336, interactions 338 with other posts, and ranked posts 340 in a data stream and suggested posts from accounts or topics. The set of metadata fields for each post or comment, user profile information, and user activity. Generating an output. The feed composer operative may include curated content 170 tagged with individually selected topics regardless of posting user using the topic-specific identifier 322 and the content-type indicator 324. The data stream may include for example a news feed and the curated content 170.

In an example embodiment, the operations performed by each of the modules and operations described in FIG. 3 may be performed by a processor. For example, memory may store instructions executable by the processor. Example processors are shown in FIG. 13 as one or more processors.

In exemplary embodiments, the system includes a topic-creation module configured to enable a user to create one or more topics associated with the user's account. The system further includes a posting interface that allows the user to publish content under the created topics, and a subscription module that enables other users to subscribe to the created topics and receive notifications of new content posted under those topics. For example, a user may create a topic called “Tennis Tips” and post instructional videos, while other users subscribe to “Tennis Tips” and receive notifications whenever new content is added.

In exemplary embodiments, the system includes a feed composer operative to generate a personalized feed for a subscribing user, wherein the personalized feed comprises only content tagged with topics selected by the subscribing user. For instance, a user may follow “Healthy Recipes” and “Yoga Techniques” topics from multiple accounts, and the system generates a feed that includes only posts tagged with those topics, regardless of the posting user.

In exemplary embodiments, the posting interface is configured to allow the posting user to attach metadata to each post, the metadata comprising at least a topic identifier, a timestamp, and a content-type indicator. For example, when a user posts a photo under “Travel Adventures,” the system automatically tags the post with the topic identifier “Travel Adventures,” the date and time, and the content type “photo.” In exemplary embodiments, the system includes an artificial intelligence assistant configured to analyze user activity and suggest sub-topics for existing topics based on posting patterns and engagement metrics. For example, the AI assistant may detect frequent posts about “Clay Court Techniques” under “Tennis Tips” and suggest creating a sub-topic “Clay Court Techniques” for more granular organization.

In exemplary embodiments, the subscription module is configured to allow a subscribing user to organize subscribed topics into custom-named feeds. For instance, a user may create a custom feed named “Weekend Inspiration” and add the topics “Outdoor Activities” and “Motivational Quotes” from different accounts to this feed.

In exemplary embodiments, the system includes a comment tagging interface configured to allow users to tag comments with one or more topic identifiers. For example, a user may comment on a post under “Book Reviews” and tag the comment with “Science Fiction,” making the comment searchable and relevant to users interested in that sub-topic.

In exemplary embodiments, the posting interface is configured to allow the posting user to merge topics with topics created by other users. For example, a user may merge their topic “Running Tips” with another user's topic “Marathon Training,” creating a consolidated topic page accessible to both sets of subscribers.

In exemplary embodiments, the system includes a post elevation module configured to receive an elevation command from a moderator user, evaluate a metric comprising at least one of a number of likes and a rate of interactions, and set a visibility flag in the metadata when the metric satisfies a threshold. For example, a post under “Photography Techniques” that receives a high number of likes may be elevated by a moderator, making it more visible in subscribers'feeds.

In exemplary embodiments, the artificial intelligence assistant is configured to rank posts in the personalized feed based on relevance to profile attributes and activity history of the subscribing user. For instance, a user's feed may prioritize posts about “Vegan Recipes” because the user frequently interacts with vegan content and has profile attributes indicating dietary preferences.

In exemplary embodiments, the system includes a presentation graphical user interface configured to display, for each post in the personalized feed, a link to the original post under the topic page from which the post originated. For example, a user may see a post about “Travel Packing Tips” in their feed and click a link to view the original post under the “Travel” topic page.

These exemplary embodiments collectively provide a flexible, user-centric platform for organizing, sharing, and discovering content based on personalized interests and topics, supported by advanced data tagging, filtering, and artificial intelligence capabilities.

Exemplary embodiments of the present technology provide a comprehensive set of features for a topic-based social media platform that enhances user engagement, content organization, and personalized feed generation.

In exemplary embodiments, the system includes a feature that allows a user to create a profile by adding a name and identifying information, thereby enabling the user to establish an account on the application.

In exemplary embodiments, the system further includes a feature that allows a user to link external social media profiles or accounts, such as a Google profile, to the user's account within the platform. This integration enables the user to receive posts and information from other social media accounts in a consolidated manner.

In exemplary embodiments, the system provides a feature that allows a user to create topic pages associated with the user's account. The user may create knowledge posts and also post other users' knowledge posts to or under the user's topics, facilitating collaborative content sharing.

In exemplary embodiments, the system includes a feature that allows an owner to add or pin other users' posts, including pictures, text, sayings, videos, or other media, under the owner's topics or any sub-topic. This enables other users to follow the owner's topic and view relevant posts under the owner's topics or subjects.

In exemplary embodiments, the system enables an owner to create posts for the owner's topics, including pictures, text, sayings, videos, or audio, and to easily attach additional comments, text, or audio to the post. The owner's original content is linked to the owner's post on the topic page, allowing for enhanced content sharing and organization.

In exemplary embodiments, the system includes a feature that allows a user to click on a post added to a feed or topic page and be directed to the original post under the corresponding subject or topic.

In exemplary embodiments, the system provides a feature that allows a user to like or agree with another user's post, thereby adding the post to the user's feed or contributing to engagement metrics.

In exemplary embodiments, the system includes a feature that enables real-time attachment of user comments to another user's post when the comment is tagged to a selected topic or subtopic. The comment is then associated with the tagged post and may be viewed alongside it.

In exemplary embodiments, the system includes a feature that allows a user to be elevated to a knowledge expert on a particular topic based on collective user input and statistical analysis of user feedback.

In exemplary embodiments, the system provides a feature that allows a user to post credentials of a selected user on any of the user's topics, enabling other users to ascertain the level of expertise of the selected user on a particular topic.

In exemplary embodiments, the home page of the system comprises four sections: the user's topic pages, feeds followed by the user and suggested feeds to follow, feeds that the user follows with additional suggested feeds, and a trending section displaying trending posts from topic pages and feeds. The system also includes a feature that allows a user to tag a post as inappropriate.

Further exemplary embodiments include features that allow an owner to share other users' posts to the owner's topic pages, to subscribers of the owner's topic pages, or to groups of individuals selected or created by the owner. The system also enables an owner to make topic pages private, thereby controlling who can view or interact with the pages. Additionally, the system allows an owner to post a status and share the status to the owner's topic pages, to subscribers of the topic pages, to groups of pre-selected individuals, or to selected individuals. Owners' topic pages may include status updates as part of their content.

In exemplary embodiments, the system includes advanced features for topic and feed management. Owners may create and name topics or interests for their pages and post under those topics. Subscribers may create and name custom feeds, aggregating posts from one or more owners' topics or subjects. The system allows users to subscribe to multiple topics or interest pages, and posts from those topics are added to the subscriber's feed under the chosen feed name.

In exemplary embodiments, the system supports reposting, merging, and elevating posts. Subscribers may repost an owner's new topic post to their own feed, and owners may add or merge other users' posts or topics with their own topic pages. The system allows owners and subscribers to elevate or like posts and comments, which can result in those posts being added to multiple feeds based on engagement metrics and filter settings.

In exemplary embodiments, the system provides robust comment and feed management. Subscribers and owners may add comments or posts to topics, delete or block comments from their feeds or topic pages, and filter what they see in their feeds based on preferences such as owner posts, all user comments, only elevated comments, or posts liked above a threshold.

In exemplary embodiments, the system utilizes artificial intelligence to assist in organizing topics and sub-topics, filtering content, and ranking posts. Input data for the AI includes user posts, profile information, activity, subscriptions, interactions, and metadata such as time and frequency of interactions. The AI generates ranked posts in a data stream, suggests new topics or sub-topics, and organizes content for personalized feeds.

In exemplary embodiments, the system enables knowledge base posts, allowing users to group together sayings, ideas, text, pictures, videos, and other media to create and share collections of knowledge on various topics such as investing, health, proverbs, games, sports, and coaching.

These exemplary embodiments collectively provide a flexible, user-centric platform for organizing, sharing, and discovering content based on personalized interests and topics, supported by advanced data tagging, filtering, and artificial intelligence capabilities.

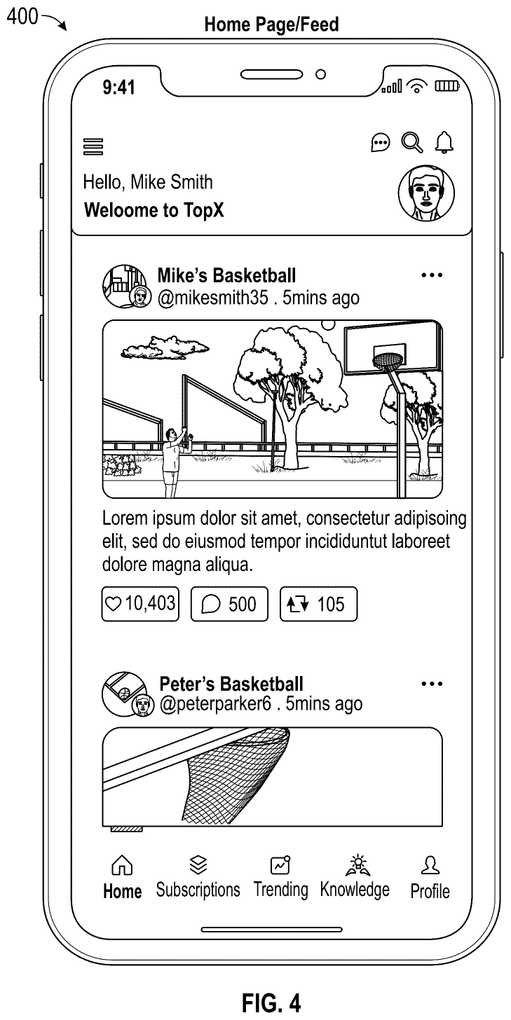

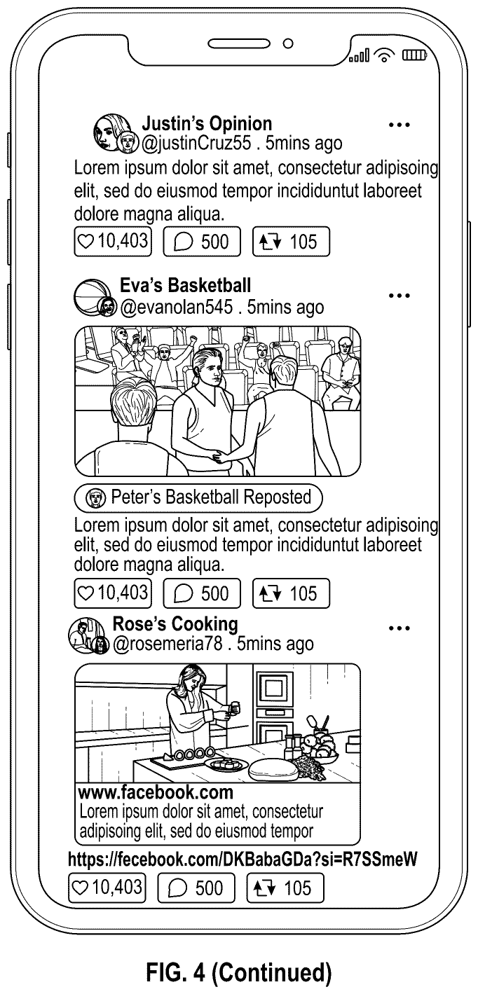

According to various embodiments, FIG. 4 through FIG. 12 illustrate exemplary presentation graphical user interfaces for data tagging and filtering for topic-based content organization, and personalized feed generation. For example, FIG. 4 illustrates an exemplary graphical user interface (GUI) showing a topic page 400 for the consolidated content data feed, according to embodiments of the present technology. FIG. 4 illustrates an exemplary graphical user interface (GUI) showing topic page 400 for the consolidated content data feed, according to embodiments of the present technology. For instance, topics may include Mike's Basketball, Eva's Basketball, Rose's cooking, and so forth. In exemplary embodiments, this interface presents curated content organized under a selected topic, allowing users to view posts, comments, and related media associated with that topic. The GUI may include features for subscribing to the topic, interacting with posts (such as liking, commenting, or sharing), and accessing links to original posts. The consolidated feed shown in FIG. 4 enables users to efficiently engage with content relevant to their interests, as filtered and organized by the system's data tagging and topic-based organization modules.

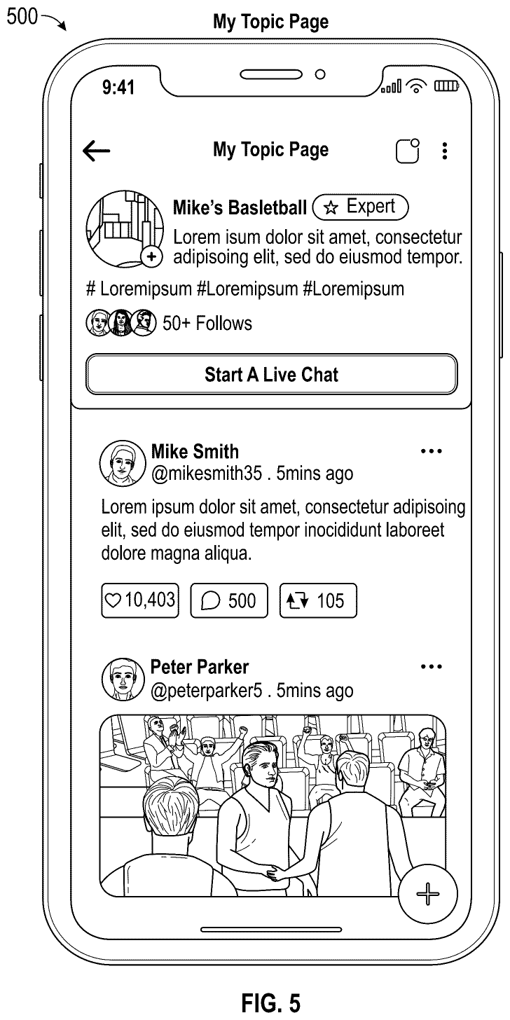

FIG. 5 illustrates an exemplary graphical user interface (GUI) showing a my topics page 500 for a subscribing user within the topic-based social media platform. In exemplary embodiments, this interface allows users to view and manage the topics they have created or are following. For instance, topics may include Mike's Basketball, and so forth. The GUI may display a list of topics associated with the user's account, provide options to add new topics, edit existing ones, and organize content under each topic. Users can interact with their topics, access related posts and comments, and customize their topic preferences, supporting efficient content organization and personalized engagement.

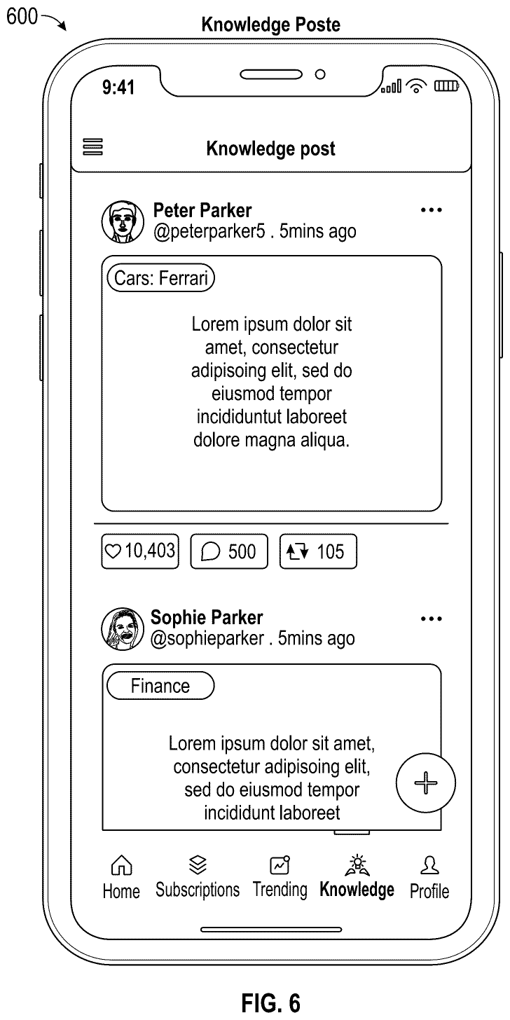

FIG. 6 illustrates an exemplary graphical user interface (GUI) showing a knowledge post 600 by a posting user, according to embodiments of the present technology. FIG. 6 illustrates an exemplary graphical user interface (GUI) showing a knowledge post 600 created by a posting user within the topic-based social media platform. In exemplary embodiments, this interface displays the content of a knowledge post, which may include text, images, videos, or other media, organized under a specific topic. For instance, a specific topic may be Cars: Ferrari, Finance, and so forth. The GUI allows users to view the details of the post, interact with it by liking, commenting, or sharing, and see any associated metadata such as the posting user's credentials or the time of posting. This interface supports the sharing and discovery of curated knowledge within user-defined topics.

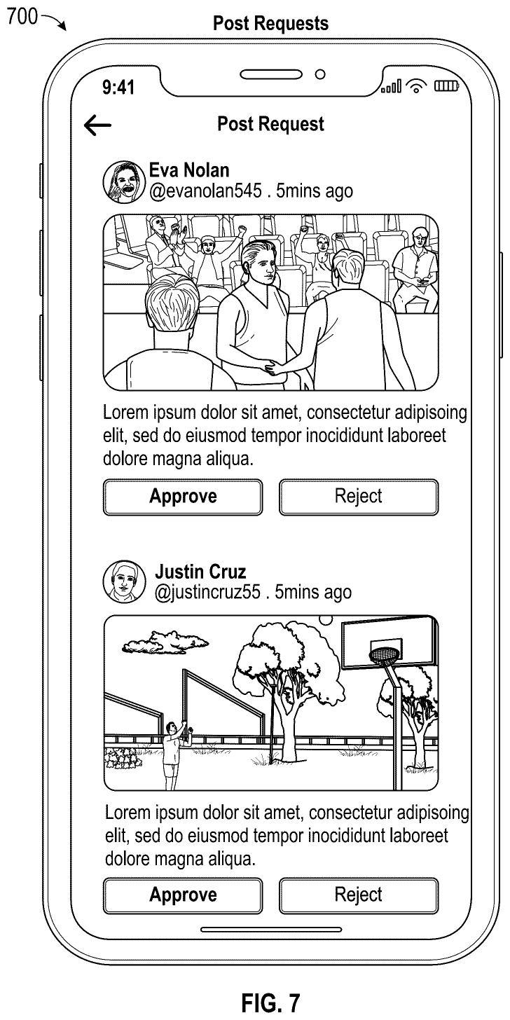

FIG. 7 illustrates an exemplary graphical user interface (GUI) showing a post request page 700 by a subscribing user to a posting user, according to embodiments of the present technology. FIG. 7 illustrates an exemplary graphical user interface (GUI) showing a post request page 700 by a subscribing user to a posting user within the topic-based social media platform. In exemplary embodiments, this interface enables a subscribing user to request the creation or sharing of content from a posting user under a specific topic. The GUI may include options for the subscriber to specify the desired topic, provide additional details or comments, and submit the request. This feature facilitates interactive content generation and engagement between users, allowing subscribers to influence the topics and types of content shared on the platform.

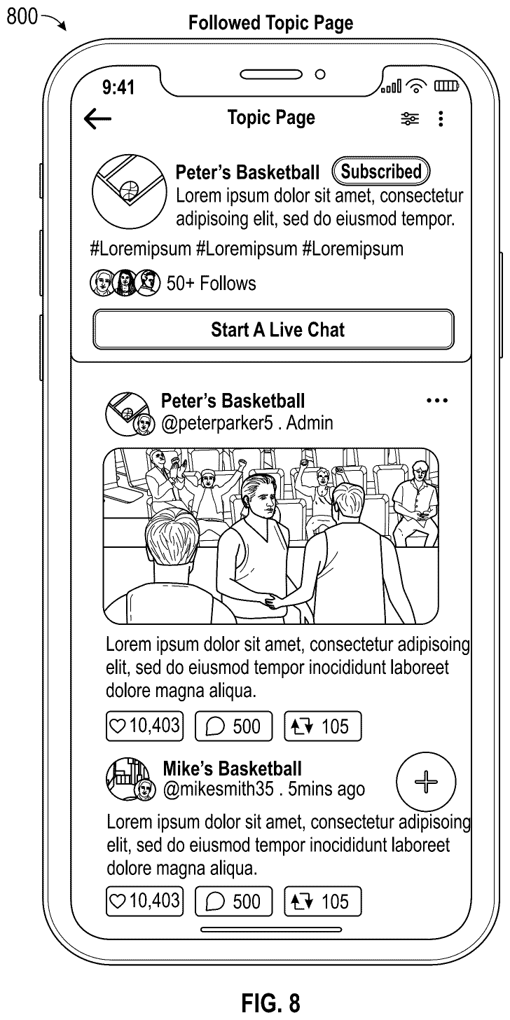

FIG. 8 illustrates an exemplary graphical user interface (GUI) showing a followed topics page 800 by a subscribing user, according to embodiments of the present technology. FIG. 8 illustrates an exemplary graphical user interface (GUI) showing a followed topics page 800 for a subscribing user within the topic-based social media platform. In exemplary embodiments, this interface allows users to view a list of topics they are currently following. For instance, Peter's Basketball, Mike's Basketball, and so forth. The GUI may provide options to manage followed topics, such as unsubscribing, organizing, or accessing posts and comments related to each topic. This feature supports personalized content engagement by enabling users to easily track and interact with topics of interest.

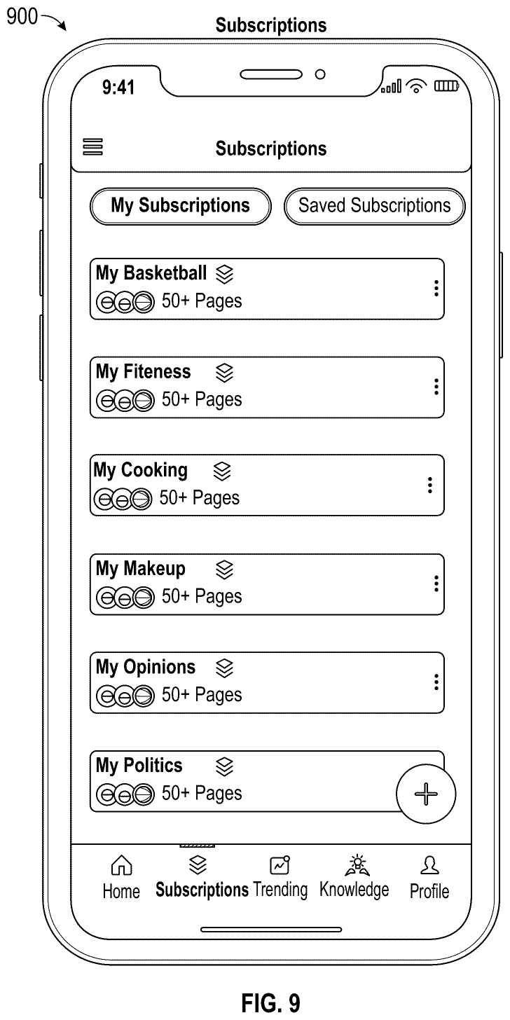

FIG. 9 illustrates an exemplary graphical user interface (GUI) showing a subscriptions page 900 by a subscribing user including topics of interest to the subscribing user, according to embodiments of the present technology. FIG. 9 illustrates an exemplary graphical user interface (GUI) showing a subscriptions page 900 for a subscribing user within the topic-based social media platform. In exemplary embodiments, this interface displays topics of interest that the subscribing user has selected or subscribed to. For instance, my subscriptions may include my basketball, my cooking, my makeup, my opinions, my politics, and so forth. The GUI may provide options for users to manage their subscriptions, view content associated with each topic, and discover new topics to follow. This feature enhances user experience by centralizing access to all subscribed topics and facilitating efficient navigation and engagement with relevant content.

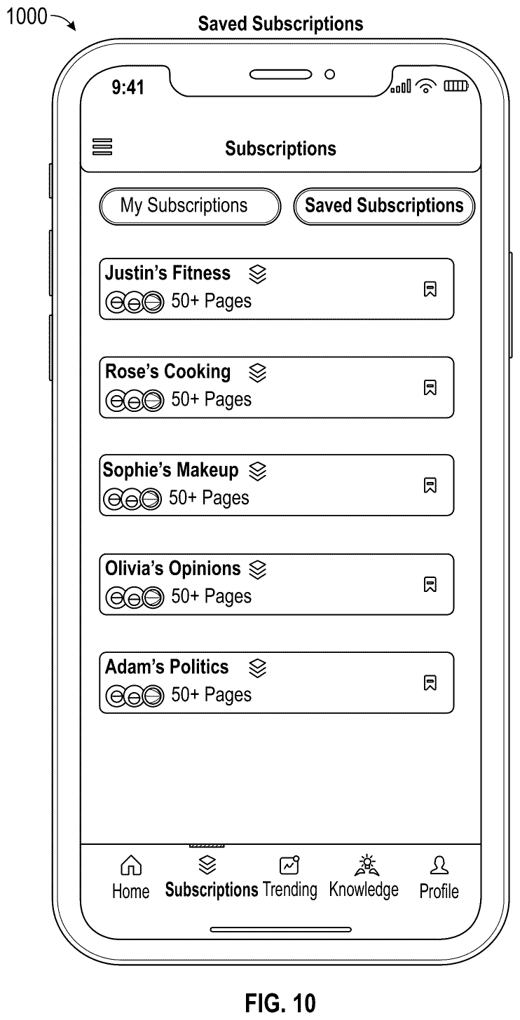

FIG. 10 illustrates an exemplary graphical user interface (GUI) showing a saved subscriptions page 1000 by a subscribing user including saved topics of interest to the subscribing user, according to embodiments of the present technology. FIG. 10 illustrates an exemplary graphical user interface (GUI) showing the saved subscriptions page 1000 for a subscribing user within the topic-based social media platform. In exemplary embodiments, this interface allows users to view and manage topics of interest that they have saved for future reference. For instance, saved subscriptions may include Justin's fitness, Rose's cooking, Sophie's makeup, Olivia's opinions, Adam's politics, and so forth. The GUI may provide options to organize, access, or remove saved topics, helping users efficiently keep track of and revisit content that aligns with their interests. This feature supports personalized content management and enhances user engagement by making it easy to access preferred topics.

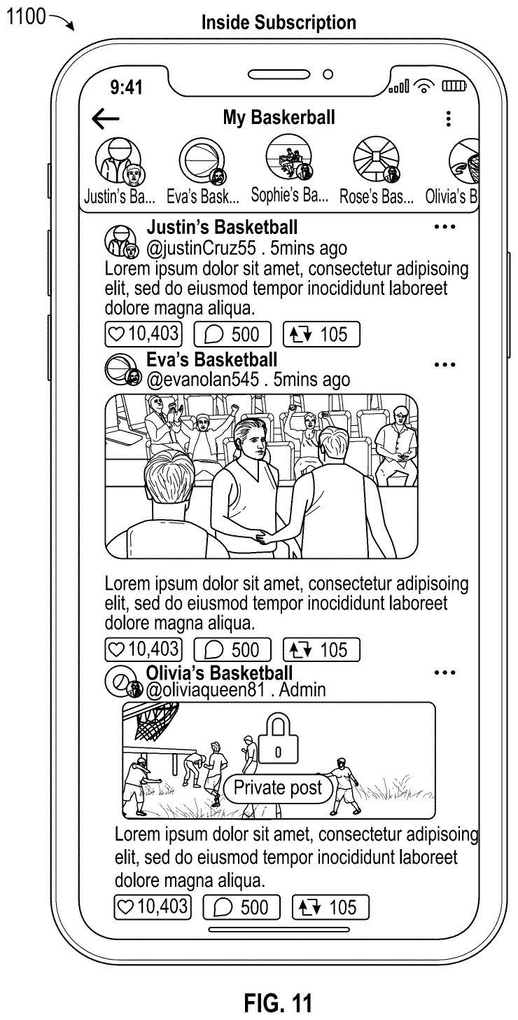

FIG. 11 illustrates an exemplary graphical user interface (GUI) showing an inside subscriptions page 1100 by a subscribing user, according to embodiments of the present technology. FIG. 11 illustrates an exemplary graphical user interface (GUI) showing an inside subscriptions page 1100 for a subscribing user within the topic-based social media platform. In exemplary embodiments, this interface allows users to view detailed information and content related to their active subscriptions. For instance, an inside subscription may include my basketball and include inside information regarding topic-based subscriptions such as Justin's basketball, Eva's basketball, Olivia's basketball, and so forth. The GUI may present posts, comments, and media associated with each subscribed topic, along with options to interact, organize, or manage the subscription. This feature supports deeper engagement and efficient navigation within the user's selected topics.

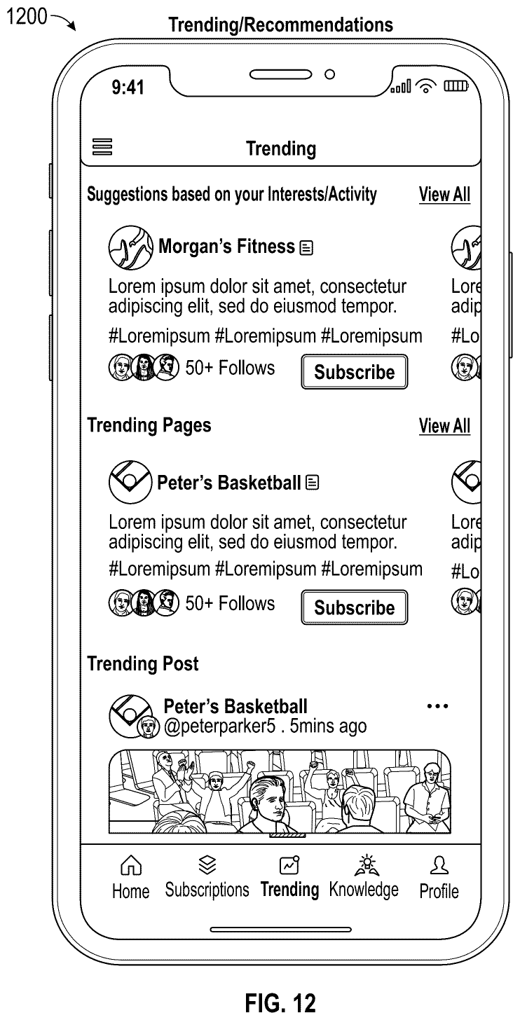

FIG. 12 illustrates an exemplary graphical user interface (GUI) showing trending recommendation subscriptions page 1200 to a subscribing user, according to embodiments of the present technology. FIG. 12 illustrates an exemplary graphical user interface (GUI) showing a trending recommendation subscriptions page 1200 for a subscribing user within the topic-based social media platform. In exemplary embodiments, this interface presents trending topics and recommended subscriptions based on user interests and activity. The GUI may display a curated list of popular or emerging topics, allowing users to discover and subscribe to new areas of interest. This feature enhances user engagement by surfacing relevant and timely content, helping users stay informed about current trends within the platform.

Embodiments include a data tagging and filtering system for sharing content that enables a user to filter the content based on personalized interests of the user, the data tagging and filtering system comprising: a topic-creation module configured to allow a posting user to define posting topics and publish the content under the posting topics; a topic-following module configured to allow a subscribing user to define subscribing topics and receive the content under the subscribing topics; a data tagging and filtering subsystem enabling matching of the posting topics and the subscribing topics, the data tagging and filtering subsystem comprising: a tagging interface configured to receive, one or more topic selections from the posting user for each post or comment from the posting user; a metadata generator configured to automatically assign to each post or comment from the posting user a set of metadata fields including a topic-specific identifier, a content-type indicator, a timestamp, a user identifier, and a post identifier; a storage module configured to store the post or comment from the posting user with the set of metadata fields associated with the post or comment in a searchable database; an indexing engine that creates and maintains an index mapping topic identifiers to post identifiers for efficient retrieval during searching of the searchable database, the topic identifiers including the topic-specific identifier and the content-type indicator; and a retrieval module that, responsive to a feed request from a feed composer, matches the topic identifiers in the set of metadata fields to the subscribing topics selected by the subscribing user and returns only posts or comments with matching topic identifiers enabling matching of the posting topics and the subscribing topics; an Artificial Intelligence (AI) assistant to assist in filtering the posting topics into posting sub-topics by taking input data comprising: the set of metadata fields for each post or comment, user profile information, and user activity including subscriptions and interactions with other posts; and generating an output including ranked posts in a data stream and suggested posts from accounts or topics, the data stream comprising a news feed; a topic-subscription engine that records, for each subscribing user, individual topics selected from a plurality of publisher accounts, the plurality of publisher accounts including the posting user; a feed composer operative to produce, for each subscribing user, a consolidated feed comprising curated content tagged with individually selected topics regardless of posting user; and a presentation graphical user interface configured to display the consolidated feed to a client device of the subscribing user, the consolidated feed comprising the curated content.

In some embodiments the topic-creation module further enables the posting user to designate a visibility setting for each posting topic, the visibility setting being selectable between a public mode and a private mode.

Some embodiments further include a post elevation module configured to receive an elevation command from a moderator user, evaluate a metric comprising at least one of a number of likes and a rate of interactions, and set a visibility flag in the set of metadata fields when the metric satisfies a threshold.

In some embodiments the AI assistant employs a machine-learning model that clusters the posting topics and automatically generates recommended sub-topic identifiers exposed to the subscribing user via a graphical subscription interface.

In some embodiments the topic-following module is further configured to allow the subscribing user to organize subscribing topics into custom-named feeds.

In some embodiments the data tagging and filtering subsystem further comprises a comment tagging interface configured to allow users to tag comments with one or more topic identifiers.

In some embodiments the storage module is further configured to store posts and comments in association with a hierarchical topic structure comprising parent topics and sub-topics.

In some embodiments the retrieval module is further configured to filter posts and comments based on a filter selection by the subscribing user, the filter selection comprising at least one of: only owner posts, all user comments, only comments elevated by the owner, and posts liked by the subscriber above a threshold.

In some embodiments the presentation graphical user interface is further configured to display, for each post in the consolidated feed, a link to an original post under a topic page from which the post originated.

In some embodiments the topic-subscription engine is further configured to allow a subscribing user to subscribe to multiple topics from multiple publisher accounts and aggregate posts from all selected topics into a single feed.

In some embodiments the AI assistant is further configured to suggest new topics or sub-topics to the posting user based on analysis of user activity and trending content.

In some embodiments the feed composer is further operative to update the consolidated feed in real-time responsive to new posts, comments, or topic changes.

In some embodiments the presentation graphical user interface is further configured to allow the subscribing user to block or delete comments from their feed.

In some embodiments the topic-creation module is further configured to allow the posting user to merge topics with topics created by other users.

In some embodiments the data tagging and filtering subsystem is further configured to allow the posting user to attach credentials to posts under selected topics.

In some embodiments the AI assistant is further configured to rank posts in the consolidated feed based on relevance to profile attributes of the subscribing user and activity history of the subscribing user.

Some embodiments include a computer-implemented method for generating machine-determined sub-topics for a parent topic in a social-media platform, the method comprising: aggregating, for the parent topic, content items posted under the parent topic, profile attributes of users interacting with the content items, and temporal interaction data; processing the aggregated data with a machine-learning model to cluster the aggregated data into a plurality of sub-topic clusters, the processing the aggregated data with the machine-learning model comprising generating an embedding for each content item using a neural network language model and applying a clustering algorithm to the embeddings, the generating the embedding for each content item using the neural network language model comprising tokenizing of each content item generating tokens, converting the tokens into vector representations, and processing the vector representations through one or more layers of the neural network to produce a fixed-length embedding vector; assigning, by the platform, a system-generated sub-topic identifier to each sub-topic cluster; updating a stored topic hierarchy such that the sub-topic identifiers are children of the parent topic; and exposing the sub-topic identifiers as selectable subscription options in a graphical user interface.

In some embodiments the generation of machine-determined sub-topics for a parent topic in a social media platform by leveraging machine learning techniques. By aggregating content items, user profile attributes, and temporal interaction data, the system processes this information using a neural network language model to create embeddings for each content item. These embeddings are clustered using algorithms such as k-means, hierarchical clustering, or density-based spatial clustering, resulting in sub-topic clusters that are assigned system-generated identifiers.

In some embodiments this arrangement provides a structured and hierarchical organization of topics, allowing users to navigate and subscribe to sub-topics that align more closely with their specific interests. The embedding generation process ensures that the clustering captures semantic relationships between content items, improving the granularity and relevance of sub-topic suggestions. For example, under a parent topic like “Tennis,” sub-topics such as “Clay Court Techniques” or “Tennis Equipment Reviews” can be automatically identified and presented to users.

In some embodiments the practical application of this method lies in the ability to reduce information overload by presenting users with highly relevant sub-topics, enhancing user engagement and satisfaction. Additionally, the hierarchical topic structure supports efficient content discovery and retrieval, as users can focus on narrower areas of interest without manually filtering through unrelated content. This approach improves the overall user experience and facilitates targeted content delivery.

In some embodiments the system-generated sub-topic identifiers streamline the integration of sub-topics into recommendation engines, enabling personalized suggestions for users who have not yet subscribed to the parent topic. This enhances the discoverability of new content and fosters user interaction with emerging trends. For instance, a recommendation engine might suggest “Tennis Nutrition Tips” to a user who frequently interacts with fitness-related content but has not subscribed to the broader “Tennis” topic. By automating the clustering and sub-topic generation process, the method also reduces the manual effort required by content creators and platform administrators to organize topics, ensuring scalability and adaptability in dynamic social media environments.

In some embodiments the generation of machine-determined sub-topics for a parent topic in a social media platform by leveraging advanced machine learning techniques. The system aggregates content items posted under the parent topic, profile attributes of users interacting with the content items, and temporal interaction data. Each content item is processed by a neural network language model, which begins by tokenizing the content item, dividing the text into discrete tokens such as words, phrases, or sub-word units. These tokens are then converted into vector representations, typically using embedding techniques that map each token to a high-dimensional numerical vector capturing semantic and contextual information.

In some embodiments the vector representations of the tokens are processed through one or more layers of the neural network to produce a fixed-length embedding vector for each content item. This embedding captures the semantic meaning and relationships within the content, enabling the system to compare and cluster content items effectively. Clustering algorithms such as k-means, hierarchical clustering, or density-based spatial clustering are then applied to the embedding vectors, resulting in the formation of sub-topic clusters. Each cluster is assigned a system-generated sub-topic identifier.

In some embodiments this process provides a structured and hierarchical organization of topics, allowing users to navigate and subscribe to sub-topics that closely match their interests. The use of tokenization and vectorization ensures that the clustering process is sensitive to the nuanced meaning and context of each content item, improving the granularity and relevance of sub-topic suggestions. For example, under a parent topic like “Tennis,” the system can automatically identify sub-topics such as “Clay Court Techniques” or “Tennis Equipment Reviews” by analyzing the semantic content of posts.

In some embodiments the technical effect of this method is a significant reduction in information overload, as users are presented with highly relevant sub-topics tailored to their interests. The hierarchical topic structure supports efficient content discovery and retrieval, allowing users to focus on specific areas without manually filtering through unrelated material. Additionally, the system-generated sub-topic identifiers facilitate integration with recommendation engines, enabling personalized suggestions for users who have not yet subscribed to the parent topic. By automating the tokenization, vectorization, and clustering processes, the method reduces manual effort for content creators and platform administrators, ensuring scalability and adaptability in dynamic social media environments. This results in improved user engagement, satisfaction, and targeted content delivery.

In some embodiments the clustering algorithm applied to the embeddings is selected from the group consisting of k-means clustering, hierarchical clustering, and density-based spatial clustering.

Some embodiments further include the updating a recommendation engine to utilize the sub-topic identifiers when calculating likelihood scores for recommending topics to users not yet subscribed to the parent topic.

Some embodiments further include updating a recommendation engine to utilize the sub-topic identifiers when calculating likelihood scores for recommending topics to users not yet subscribed to the parent topic.

In some embodiments the Artificial Intelligence (AI) assistant is a machine-learning-based system integrated into the platform to analyze user activity, profile information, and metadata, providing functionalities such as ranking posts, suggesting topics or sub-topics, and organizing content for personalized feeds.

In some embodiments the content-type indicator is a metadata field that specifies the type of content in a post, such as text, image, video, or audio, to facilitate categorization and retrieval.

In some embodiments the curated content is posts or comments that have been filtered, ranked, or selected based on user preferences, topic subscriptions, or AI-driven recommendations, and presented in a personalized feed.

In some embodiments the data tagging and filtering subsystem is a system component responsible for assigning metadata to posts and comments, indexing content for efficient retrieval, and filtering content based on user-defined topics or preferences.

In some embodiments embedding a vector is a fixed-length numerical representation of a content item, generated by a neural network language model, that captures the semantic meaning and relationships within the content for clustering and analysis.

In some embodiments the feed composer is a system module that generates a consolidated feed for a user by aggregating and organizing content tagged with topics selected by the user.

In some embodiments the hierarchical topic structure is an organizational framework where topics are arranged in a parent-child relationship, allowing for the creation of sub-topics under broader parent topics.

In some embodiments the indexing engine is a system component that creates and maintains an index mapping topic identifiers to post identifiers, enabling efficient retrieval of content during searches.

In some embodiments the metadata is structured data fields associated with posts or comments, including topic-specific identifiers, timestamps, user identifiers, content-type indicators, and post identifiers, used for categorization and retrieval.

In some embodiments the metadata generator is a system module that automatically assigns metadata fields to posts and comments, ensuring consistent tagging and organization of content.

In some embodiments a parent topic is a primary or overarching topic under which sub-topics are organized, forming part of the hierarchical topic structure.

In some embodiments a personalized feed is a dynamically generated content stream tailored to a user's interests, based on their topic subscriptions, interactions, and preferences.

In some embodiments a post elevation module is a system feature that allows a moderator or owner to increase the visibility of a post based on metrics such as likes or interaction rates, making it more prominent in user feeds.

In some embodiments posting topics are thematic categories defined by a posting user under which content is published, enabling better organization and discoverability.

In some embodiments a retrieval module is a system component that matches metadata fields of posts or comments with user-selected topics and retrieves relevant content for display in a feed.

In some embodiments subscribing topics are topics selected by a user to follow, which determine the content included in their personalized feed.

In some embodiments a sub-topic is a more specific or granular category derived from a parent topic, often generated automatically by the AI assistant based on content clustering.

In some embodiments a tagging interface is a user interface that allows posting users to select topics for their posts or comments, ensuring proper categorization within the system.

In some embodiments a Topic-Specific Identifier is a unique metadata field assigned to a topic, used to tag and retrieve content associated with that topic.

In some embodiments a Visibility Setting is a user-defined parameter for a topic that determines whether the topic is public (accessible to all users) or private (restricted to selected users).

FIG. 13 illustrates an exemplary computer system that may be used to implement embodiments of the present disclosure. FIG. 13 is an exemplary diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as a Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 1 includes a processor or multiple processor(s) 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processor(s) 5 during execution thereof by the computer system 1. The main memory 10 and the processor(s) 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

Where appropriate, the functions described herein can be performed in one or more of hardware, software, firmware, digital components, or analog components. For example, the encoding and or decoding systems can be embodied as one or more application specific integrated circuits (ASICs) or microcontrollers that can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.” Various modifications and alterations of the invention will become apparent to those skilled in the art without departing from the spirit and scope of the invention, which is defined by the accompanying claims. It should be noted that steps recited in any method claims below do not necessarily need to be performed in the order that they are recited. Those of ordinary skill in the art will recognize variations in performing the steps from the order in which they are recited. In addition, the lack of mention or discussion of a feature, step, or component provides the basis for claims where the absent feature or component is excluded by way of a proviso or similar claim language.

While various embodiments of the present invention have been described above, it should be understood that they have been presented by way of example only, and not of limitation. The various diagrams may depict an example architectural or other configuration for the invention, which is done to aid in understanding the features and functionality that may be included in the invention. The invention is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the present invention. Also, a multitude of different constituent module names other than those depicted herein may be applied to the various partitions.

Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the such as; the term “example” is used to provide exemplary instances of the item in discussion, not an exhaustive or limiting list thereof; the terms “a” or “an” should be read as meaning “at least one,” “one or more” or the such as; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Hence, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other such as phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

It is to be understood that the above description is intended to be illustrative, and not restrictive. For example, the above-described embodiments (and/or aspects thereof) may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein. ” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects. The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, various features may be grouped together to streamline the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separate embodiment.

Thus, the present technology for data tagging and filtering for topic-based content organization, and personalized feed generation is disclosed. Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

What is claimed is:

1. A data tagging and filtering system for sharing content that enables a user to filter the
content based on personalized interests of the user, the data tagging and filtering system comprising:
a topic-creation module configured to allow a posting user to define posting topics and publish the content under the posting topics;
a topic-following module configured to allow a subscribing user to define subscribing topics and receive the content under the subscribing topics;
a data tagging and filtering subsystem enabling matching of the posting topics and the subscribing topics, the data tagging and filtering subsystem comprising:
a tagging interface configured to receive, one or more topic selections from the posting user for each post or comment from the posting user;
a metadata generator configured to automatically assign to each post or comment from the posting user a set of metadata fields including a topic-specific identifier, a content-type indicator, a timestamp, a user identifier, and a post identifier;
a storage module configured to store the post or comment from the posting user with the set of metadata fields associated with the post or comment in a searchable database;
an indexing engine that creates and maintains an index mapping topic identifiers to post identifiers for efficient retrieval during searching of the searchable database, the topic identifiers including the topic-specific identifier and the content-type indicator; and
a retrieval module that, responsive to a feed request from a feed composer, matches the topic identifiers in the set of metadata fields to the subscribing topics selected by the subscribing user and returns only posts or comments with matching topic identifiers enabling matching of the posting topics and the subscribing topics;
an Artificial Intelligence (AI) assistant to assist in filtering the posting topics into posting sub-topics by taking input data comprising: the set of metadata fields for each post or comment, user profile information, and user activity including subscriptions and interactions with other posts; and generating an output including ranked posts in a data stream and suggested posts from accounts or topics, the data stream comprising a news feed;
a topic-subscription engine that records, for each subscribing user, individual topics selected from a plurality of publisher accounts, the plurality of publisher accounts including the posting user;
a feed composer operative to produce, for each subscribing user, a consolidated feed comprising curated content tagged with individually selected topics regardless of posting user; and
a presentation graphical user interface configured to display the consolidated feed to a client device of the subscribing user, the consolidated feed comprising the curated content.

2. The system of claim 1, wherein the topic-creation module further enables the posting user to designate a visibility setting for each posting topic, the visibility setting being selectable between a public mode and a private mode.

3. The system of claim 1, further comprising a post elevation module configured to receive an elevation command from a moderator user, evaluate a metric comprising at least one of a number of likes and a rate of interactions, and set a visibility flag in the set of metadata fields when the metric satisfies a threshold.

4. The system of claim 1, wherein the AI assistant employs a machine-learning model that clusters the posting topics and automatically generates recommended sub-topic identifiers exposed to the subscribing user via a graphical subscription interface.

5. The system of claim 1, wherein the topic-following module is further configured to allow the subscribing user to organize subscribing topics into custom-named feeds.

6. The system of claim 1, wherein the data tagging and filtering subsystem further comprises a comment tagging interface configured to allow users to tag comments with one or more topic identifiers.

7. The system of claim 1, wherein the storage module is further configured to store posts and comments in association with a hierarchical topic structure comprising parent topics and sub-topics.

8. The system of claim 1, wherein the retrieval module is further configured to filter posts and comments based on a filter selection by the subscribing user, the filter selection comprising at least one of: only owner posts, all user comments, only comments elevated by the owner, and posts liked by the subscriber above a threshold.

9. The system of claim 1, wherein the presentation graphical user interface is further configured to display, for each post in the consolidated feed, a link to an original post under a topic page from which the post originated.

10. The system of claim 1, wherein the topic-subscription engine is further configured to allow a subscribing user to subscribe to multiple topics from multiple publisher accounts and aggregate posts from all selected topics into a single feed.

11. The system of claim 1, wherein the AI assistant is further configured to suggest new topics or sub-topics to the posting user based on analysis of user activity and trending content.

12. The system of claim 1, wherein the feed composer is further operative to update the consolidated feed in real-time responsive to new posts, comments, or topic changes.

13. The system of claim 1, wherein the presentation graphical user interface is further configured to allow the subscribing user to block or delete comments from their feed.

14. The system of claim 1, wherein the topic-creation module is further configured to allow the posting user to merge topics with topics created by other users.

15. The system of claim 1, wherein the data tagging and filtering subsystem is further configured to allow the posting user to attach credentials to posts under selected topics.

16. The system of claim 1, wherein the AI assistant is further configured to rank posts in the consolidated feed based on relevance to profile attributes of the subscribing user and activity history of the subscribing user.

17. A computer-implemented method for generating machine-determined sub-topics for a parent topic in a social-media platform, the method comprising:
aggregating, for the parent topic, content items posted under the parent topic, profile attributes of users interacting with the content items, and temporal interaction data;
processing the aggregated data with a machine-learning model to cluster the aggregated data into a plurality of sub-topic clusters, the processing the aggregated data with the machine-learning model comprising generating an embedding for each content item using a neural network language model and applying a clustering algorithm to the embeddings, the generating the embedding for each content item using the neural network language model comprising tokenizing of each content item generating tokens, converting the tokens into vector representations, and processing the vector representations through one or more layers of the neural network to produce a fixed-length embedding vector;
assigning, by the platform, a system-generated sub-topic identifier to each sub-topic cluster;
updating a stored topic hierarchy such that the sub-topic identifiers are children of the parent topic; and
exposing the sub-topic identifiers as selectable subscription options in a graphical user interface.

18. The method of claim 17, wherein the clustering algorithm applied to the embeddings is selected from the group consisting of k-means clustering, hierarchical clustering, and density-based spatial clustering.

19. The method of claim 17, further comprising updating a recommendation engine to utilize the sub-topic identifiers when calculating likelihood scores for recommending topics to users not yet subscribed to the parent topic.

20. The method of claim 17, further comprising updating a recommendation engine to utilize the sub-topic identifiers when calculating likelihood scores for recommending topics to users not yet subscribed to the parent topic.
